(19) United States
(12) Patent Application Publication
(10) Pub. No.: US 2019/0234227 A1
(43) Pub. Date: Aug. 1, 2019

(54) POWERING GENERATOR INSTRUMENTATION VIA MAGNETIC INDUCTION

(71) Applicant: Siemens Energy, Inc., Orlando, FL (US)

(72) Inventor: Joshua S. McConkey, Orlando, FL (US)

(21) Appl. No.: 15/882,037

(22) Filed: Jan. 29, 2018

(51) Int. Cl. F01D 15/10; H02J 50/10

(52) U.S. Cl. CPC F01D 15/10; H02J 50/10

(57) ABSTRACT

A system for powering instrumentation of a generator wirelessly via magnetic induction is provided. The system includes a generator having a power generating source disposed within its casing to convert the electromagnetic energy produced by the generator into electrical energy that may be stored in an energy storage device. This stored energy may then be utilized by at least one sensing component within the generator casing and configured to measure and collect operational data related to the generator. A method for powering a wireless sensor within a generator via magnetic induction is also provided.

### BACKGROUND

### 1. Field

The present application relates generally to generators, and more particularly to instrumentation used for wirelessly measuring parameters inside a generator.

### 2. Description of the Related Art

A generator is a component of a power plant that converts mechanical energy to electrical energy. The generator comprises a stator core wound by stator windings in which a current develops as a result of an electromagnetic force created by a rotating generator rotor.

A typical generator has a multitude of parameters that are measured with instrumentation such as sensors. Sensor networks have been used for monitoring various parameters of power generation units, such as generators, within a power generation plant, for example, to avoid possible system failures. While providing beneficial data on the operating conditions of the generator, the instrumentation is very costly. Approximately half of the instrumentation costs is due to the wiring associated with the instrumentation and conduit installation needed to support the wiring. Thus, switching over to wireless instrumentation would save on these costs along with simplifying the installation of the instrumentation.

New wireless data transmission technologies only partially enables the use of wireless instrumentation. Power is currently provided to the sensors and other instrumentation associated with measuring generator parameters through wiring. Other solutions for providing power to the sensors such as solar, vibration harvesting, heat differential harvesting, etc. have all failed to produce any usable amounts of power in a generator enclosure.

Thus, any wireless data solution would be vastly improved by providing power wirelessly to the instruments that reside on or near the generator. Consequently, it is an objective of this disclosure to provide a solution for wirelessly powering generator instrumentation.

### SUMMARY

Briefly described, aspects of the present disclosure relate to a system and method powering instrumentation of a generator wirelessly via magnetic induction.

The provided system includes a power generator source disposed within a casing of a generator, the generator capable of generating power. The power generating source harnessing the ambient electromagnetic energy within the generator casing produced by the generator to power a power source of a generator component. The generator component comprises a sensing component, the sensing component capable of collecting operational data related to parameters of the generator coupled to the power source and therefore receiving electrical power from the power generating source.

The provided method for powering a wireless sensor within a generator via magnetic induction includes generating power via magnetic induction within a generator casing to completely power a sensing component and providing the power to the sensing component. The sensing component collects operational data related to parameters of the generator.

### BRIEF DESCRIPTION OF THE DRAWINGS

FIG. 1 illustrates an axial cross-sectional view of a generator and an exemplary control system for collecting and analyzing operational data from the generator,

FIG. 2 illustrates a block diagram of a circuit used to harvest and deliver power to generator instrumentation, and

FIG. 3 illustrates a configuration of a power generating device.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

Present embodiments relate to harvesting electromagnetic energy within a generator enclosure in order to power instrumentation for measuring parameters of the generator. The presently described system and method utilizes the time-varying magnetic field within the generator enclosure to produce an alternating current which may be rectified and used to power instrumentation. The system may store the power in, for example, a rechargeable battery.

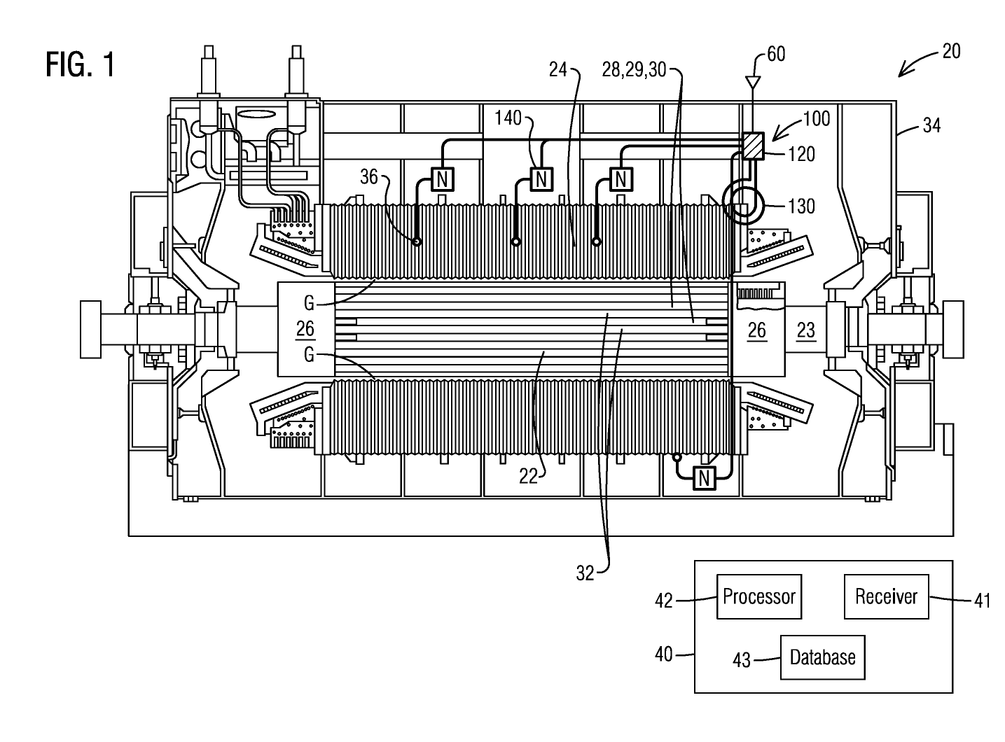

Referring to FIG. 1, an exemplary generator 20 for generating electricity is shown. The generator includes a rotor 22 mounted on a rotor shaft 23. The rotor 22 is circumscribed within a bore of a stator 24, separated from each other by an annular air gap G. Electrical generator retaining rings 26 are coupled to the rotor 22 at each of the latter's axial ends. Rotor windings 28 have axial portions 29 that are respectively oriented within respective rotor winding channels 30, circumscribed by the stator 24 bore and the air gap G. The rotor winding channels are circumferentially separated by rotor teeth 32. This generator equipment is enclosed within a generator casing 34.

Sensors disposed within the generator casing 34 may be used to monitor various parameters within the generator 20. As an example of a sensor used to monitor a parameter within the generator 20, a thermal sensor 36, such as a thermocouple, may be inserted into the stator windings 24 as shown in order to measure the temperature of the internal components and cooling flows of the generator 20.

As an example of a sensor used within a generator, thermocouples and resistive thermal devices (RTDs) are temperature sensors utilized to give an indication of the condition of the generator. While thermocouples are used within this disclosure as an example of a generator sensor, other types of sensors such as pressure sensors measuring pressure, humidity sensors measuring the humidity at the location, level sensors measuring gas or fluid levels, and actuator sensors that measure valve or actuator positions, along with many other types of sensors may be utilized as the sensor measuring various conditions within the generator.

A control system 40 is also shown in FIG. 1 for monitoring operational data collected from the sensors 36 within the generator 20. The control system 40 is disposed externally from the generator casing 34 and may include a receiver 41, a processor 42 or central processing unit (CPU), and a database 43. The receiver 41 may be configured to receive wireless data transmitted from a transmitter, such as an antenna 60 shown in FIG. 1, disposed within the generator casing 34. The antenna 60 may be the only component of the proposed system for powering generator instrumentation that protrudes through the generator casing 34. The receiver 41 may be in operable communication with the processor 42 and/or database 43. In an embodiment, the processor 42 processes the operational data from the sensor 36 to describe a condition of the generator 20. If the condition warrants that a change be made to the generator 20, the control system 40 may change an operating parameter of the generator 20. As an example, if a temperature limit is exceeded, the cooling flow may be increased or the generator 20 may be shut down.

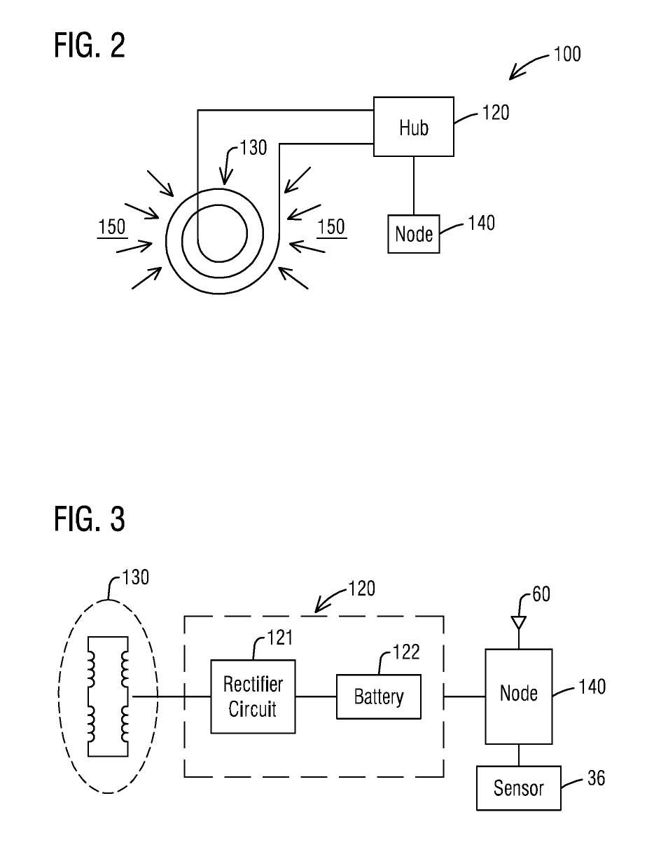

Referring now to FIG. 2, a block diagram of a circuit 100 is shown in accordance with an embodiment. The circuit 100 generates power for powering instrumentation and delivers the power to the instrumentation so that the instrumentation can measure parameters of the generator 20 without wiring. The circuit 100 may be disposed within a generator casing 34, as shown in FIG. 1, or another location in which a time-varying magnetic field exists during operation of the generator 20. The time-varying magnetic field 150 induces an alternating current within a power coil 130. Only a small percentage of energy produced from the generator 20 is needed for the circuit 100 to generate sufficient power to completely power a generator component, such as a sensor 36. For example, a typical generator may generate 50 MW of power while a battery or power source of the generator component or plurality of generator components may only require 1 W of power and in some embodiments as low as 250 mW of power.

A power generating source may include a power coil 130 and a hub 120 containing circuitry to convert alternating circuit into direct current. The power coil 130 may comprise a simple loop or looped coil. The induced alternating current is introduced into the hub 120. From the power generating source 120, 130, a node 140 comprising one sensor may be powered. The node 140 communicates directly with the sensor 36. In an embodiment, the power generating source 120, 130 generates power in a range of 20 mW to 1 W.

FIG. 3 illustrates a configuration of the power generating source 120, 130 and the electrical components within the hub 120. The hub 120 includes a rectifier circuit 121 and a power source 122. In the shown embodiment, the power source 122 comprises a rechargeable battery. The alternating current (AC), generated in the power coil 130, flows into the rectifier circuit 121 where it is converted into direct current (DC). A conversion to direct current (DC) may be desirable for power storage as a constant steady current/voltage is necessary to charge the rechargeable battery 122.

The rectifier circuit 121 may be made up of diodes, for example. In an embodiment, the rectifier 121 may be a bridge rectifier 121. The output, in DC current, of the rectifier circuit 121 may then be conducted to the power source 122, which in the illustrated example of FIG. 3 is a rechargeable battery. The battery 122 may be used to power both the hub circuit 120 as well as the node 140. Further, power stored in the rechargeable battery 122 may be used to power the sensors 36 even when the generator 20 is not in operation so that the sensors 36 may continue to collect data when the generator 20 is offline. Additionally, the collected sensor data may be stored in the database 43 and accessed when needed.

In an embodiment, the sensor 36 may output its operational data to a wireless transmitter 60 for wireless transmission to an external receiver 41. The wireless transmitter 60 may be an antenna for example. FIG. 3 illustrates a node 140 operably connected to an antenna 160 for wireless transmission of sensor operational data. In an embodiment, the transmitter 60 may be powered by the power source 122 of the power generating source 120, 130. The operational data per node 140 may be transmitted in real-time. In this embodiment, the power generating device 120, 130 may report sensor data, such as temperature data, at rates of at least once per second.

Within the generator casing 34, a plurality of circuits 100 for generating power may exist. Each circuit 100 may contain a hub 120 comprising 1-9 nodes 140, each node 140 comprising at least one sensor 36. In an embodiment, each node 140 is operably connected to the hub 120 within the circuit 100 via a wired connection. In the embodiment of the wired connection, each node 140 may lie approximately 100 meters from the hub 120. In another embodiment, each node 140 is operably connected to the hubs via a wireless connection. In the embodiment of the wireless connection, each node 140 may lie approximately 250 meters from the hub 120.

In an embodiment, the sensors 36 in a node 140 may be configured in a Hyper redundant configuration as described in U.S. patent application Ser. No. 15/229,244 which is hereby incorporated by reference. However, instead of an external power source delivering power to the sensor nodes via a wired configuration, the hyper-redundant configuration of sensor nodes may include a power generating source powering a power source for each sensor node so that the sensor nodes operate wirelessly.

The environment inside the generator casing 34 where the sensors 36 operate is subject to high temperatures and may include exposure to hydrogen which is known to be an explosive gas. Large generators in power plants are cooled with hydrogen as a rule. Thus, in an embodiment, the hub 120 including the rechargeable battery 122 and rectifier circuit 121 is encapsulated with epoxy preventing an influx of explosive gas. Likewise, each node 140 may also be encapsulated with epoxy to prevent an influx of explosive gas within the node of sensors.

Referring to FIGS. 1-3, a method for powering a wireless sensor within a generator via magnetic induction is also provided. The method includes the following steps:
Generating power via magnetic induction to completely power a rechargeable battery of a sensing component within a casing of a generator,
Providing the power to the sensing component.

It may be appreciated that in operation, the disclosed system and method for powering instrumentation of a generator wirelessly via magnetic induction provides a reliable and cost-effective solution for measuring various parameters within a generator without the use of wiring eliminating costly wiring and failures due to wiring faults. Additionally, the system transmits the operational data quickly, in real-time, so that decisions about the operational aspects and fault conditions within the generator may be diagnosed quickly with appropriate changes and/or repairs made in due time. Furthermore, the system has the potential to provide auxiliary power for additional instrumentation located outside the generator without having to provide a wired solution.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

1. A system for powering instrumentation of a generator wirelessly via magnetic induction, comprising:
a generator capable of generating power;
a power generating source disposed within a casing of the generator generating power via magnetic induction in order to power a power source of a generator component; and
a sensing component, capable of collecting operational data related to parameters of the generator, wirelessly coupled to the power source and receiving electrical power generated by the power generating source,
wherein the generator component comprises the sensing component 36.

2. The system as claimed in claim 1, further comprising a wireless transmitter for transmitting the operational data to a receiver external to the generator casing 34.

3. The system as claimed in claim 2, wherein the generator component further comprises the transmitter.

4. The system as claimed in claim 2, wherein the operational data is transmitted to the external receiver at least once per second.

5. The system as claimed in claim 1,
wherein the power generating source comprises a power coil connected to a hub,
wherein the hub includes a rectifier circuit and the power source, and
wherein an alternating current is produced within the power coil via magnetic induction due to a time-varying magnetic field within the generator casing.

6. The system as claimed in claim 1, wherein the power source comprises a rechargeable battery.

7. The system as claimed in claim 6, wherein power is stored in the rechargeable battery and utilized by the sensing component.

8. The system as claimed in claim 6, wherein the sensing component operates when the generator is not generating power by utilizing the power stored in the rechargeable battery.

9. The system as claimed in claim 1, wherein power generating source generates power in a range of 20 mW to 2 W.

10. The system as claimed in claim 6, wherein the hub including the rechargeable battery and rectifier circuit is encapsulated with epoxy preventing an influx of explosive gas.

11. The system as claimed in claim 1, further comprising a plurality of sensing components selected from a range between 2-8, each of the plurality of sensing components operably communicate with a node.

12. The system as claimed in claim 11, wherein each node is encapsulated with epoxy preventing an influx of explosive gas.

13. The system as claimed in 2, further comprising a control system the control system including a processor and the external receiver,
wherein the processor is in operable communication with the external receiver for processing the operational data transmitted by the sensing component to describe a condition of the generator at least once per second.

14. The system as claimed in claim 13, wherein the control system uses the condition of the generator to change operating parameters on the generator.

15. A method for powering a wireless sensor within a generator via magnetic induction, comprising:
generating power via magnetic induction to completely power a sensing component within a casing of the generator; and
providing the power wirelessly to the sensing component,
wherein the sensing component collects operational data related to parameters of the generator.

16. The method as claimed in claim 15, further comprising transmitting by a wireless transmitter the operational data to a receiver external to the generator casing.

17. The method as claimed in claim 16, wherein the operational data is transmitted to the external receiver at least once per second.

18. The method as claimed in claim 16, wherein the power is stored in a rechargeable battery and utilized by the sensing component.

19. The method as claimed in claim 18, wherein the sensing component operates when the generator is not generating power by utilizing the power stored in the rechargeable battery.

20. The method as claimed in claim 16, wherein power generating source generates power in a range of 20 mW to 2 W.
